(19) United States
(12) Patent Application Publication
(10) Pub. No.: US 2003/0088771 A1
(43) Pub. Date: May 8, 2003

(54) Method and system for authorizing and certifying electronic data transfers

(76) Inventor: M. Russel Merchen, (US)

Correspondence Address: Gardere Wynne Sewell, LLP, 3000 Thanksgiving Tower, 1601 Elm Street Suite 3000, Dallas, TX, 75201-4767, US

(21) Appl. No.: 09/837,884

(22) Filed: Apr. 18, 2001

(51) Int. Cl. H04L 9/00

(52) U.S. Cl. 713/175; 713/178

(57) ABSTRACT

The present invention provides a method and system for creating non-repudiated digital receipts and electronic signatures for electronic transactions. More specifically, the present invention provides a method, computer program and system for authorizing an electronic data transfer. An authentication request containing a digital certificate is received from a requesting device via a communication link. The present invention then determines whether the digital certificate is valid, and creates an authentication response denying the authentication request when the digital certificate is not valid, or approving the authentication request when the digital certificate is valid. The authentication response is then sent to the requesting device via the communication link, and information about the electronic data transfer, the digital certificate and at least a portion of the authentication response are stored.

### FIELD OF THE INVENTION

The present invention relates generally to the field of electronic information exchange and, in particular, to a method and system for authorizing and certifying electronic data transfers.

### BACKGROUND OF THE INVENTION

People have become increasingly concerned about maintaining the privacy and security of their personal information, especially medical information. Despite the fact that the United States healthcare industry offers the most advanced and sophisticated treatment solutions to patients, the methodology for communicating patient information between providers, and with payers, remains rather crude, non-standardized, and open for abuse and fraud. This was the primary motivation behind the federal government's implementation of the Health Insurance Portability and Accountability Act (“HIPAA”) of 1996. HIPAA provides minimum guidelines for the protection, security and standardization of protected patient health information, whether electronically transmitted or electronically stored. HIPAA does not, however, specify how these guidelines are to be implemented into a useable system.

HIPAA compliance refers to all electronic claims transaction, not just to Medicare and/or Medicaid. There are nine areas that must be in compliance at every physician's office, hospital, healthcare plan, fiscal intermediary, outsourced or consolidated business office, vendor, payer, or data clearinghouse. Healthcare Providers (“HCP's”) who elect to conduct the administrative and financial transactions electronically must comply with the standards in each of these nine areas: individual identifiers, employer identifiers, health plan or payer identifiers, healthcare provider identifiers, code sets, security, electronic signatures, coordination of benefits and security. A HCP is any entity involved in the deliverance of health care services and pharmaceutical products.

Compliance will be a serious issue. Protected Health Information requirements (Privacy & Security) will place the burden on providers, payers and health plans to use security on any individually identifiable medical information that is electronically transmitted or electronically stored. Stiff fines and criminal charges will be levied on both institutions and individuals found to be in non-compliance with certain portions of HIPAA. As a result, all HCP's will be required to make the necessary changes towards compliance.

HIPAA compliance will be an onerous task because every electronic/medical records software application used by the HCP's must be modified or replaced. The bottom line is that there is not enough time to develop all of the unique “fixes” for each of the different products that will require HIPAA compliance. Moreover, there is growing uncertainty amongst HCP's as to how to implement HIPAA's demanding standards into their own operations. Many are already beginning to state that they do not have the time or the resources to meet the upcoming deadlines. One example of the difficulties that must be overcome involves prescriptions.

Approximately 95 percent of prescriptions filled today are paper-based. These paper-based transactions offer almost no security, while significantly increasing the likelihood for fraud and abuse. As a result, the National Committee for Prescription Drug Pharmacists (“NCPDP”) has recommended that all prescriptions be filled and submitted electronically within the next three (3) years. In addition, by 2003, all physicians and pharmacists will be subject to HIPAA regulations that will require authentication and validation on all electronic prescription (“ePrescription”) transactions. This is a significant technological hurdle when one considers that there are currently three (3) billion retail prescriptions written each year. Moreover, many pharmacists fill an average of 250 prescriptions a day. Some pharmacists, particularly in metropolitan areas, fill over 900 prescriptions a day.

Historically, the patient has acted as the delivery mechanism for getting a prescription from a physician to a pharmacist. Even with the advancements in computer technology, little has changed within the last century in terms of prescribing medications. Keeping the patient in the delivery loop presents several problems:

The potential exists for patients altering their prescriptions illegally.

Patients may duplicate their prescription in order to get unauthorized multiple refills at different pharmacies or locations.

Handwritten prescriptions are less legible and can cause dispensing errors or delays in dispensing.

Current processes are time consuming, forcing too much time to be spent between pharmacists and the prescribing physician to confirm or ask questions about the script.

The physician has no notification system that the patient had the prescription filled.

Abuse of the medication by the patient (intentional or unintentional) resulting in a negative clinical outcome for the patient—including death.

As a result of these problems, a need exists to improve accuracy and reduce injury and possible death caused by misfiled prescriptions. Many pharmacies also accept faxed prescriptions. A common method of verifying from whom the prescription was sent is to check the fax number at the top of the fax. It is a simple matter to change the fax number that appears at the top of a fax to indicate the source as a doctor. Also, through the use of devices such as scanners, it is easy to copy a doctor's stationary and signature and print it with the same color and clarity as the “real thing.”

In an effort to reduce fraud in the distribution of controlled substances, the Drug Enforcement Administration (“DEA”) is currently establishing the Public Key Infrastructure (“PKI”) framework for being a root Certificate Authority (“CA”) to issue digital certificates to all physicians who prescribe narcotics. The DEA intends to develop guidelines to implement secure electronic prescriptions between physicians and pharmacies when controlled substances are prescribed. Within those guidelines the DEA has determined the following obligations for pharmacies:

Verification of the prescription signature.

Validate the practitioner's status.

Maintain the electronic prescription in an archive or vault for two years.

Electronically sign the prescription record.

HIPAA will require that all ePrescriptions from a physician to a pharmacist must first be authenticated. This is required to insure that the identity of both parties (entity authentication) are exactly who they are believed to be. The law also requires that all transactions be conducted in such a manner that neither side can deny that the transaction—or any component of it—took place (i.e., a legally required audit trail). These audit trails create what is called “non-repudiation.” Non-repudiation means that there is a “legal grade” digital receipt that provides strong and substantial evidence that will make it difficult for the signer to claim that the electronic representation is not valid.

Although some existing proprietary electronic prescription systems provide some sort of authentication, most do not perform any authentication at all. None of the electronic prescription vendors in the market place today meet all the required HIPAA regulations, such as non-repudiation services and a clear audit trail for all electronic transactions. Therefore, validation technology is needed to meet requirements for authentication and non-repudiation of electronic data transfers. In addition, vendors must also address the non-tamperability requirements.

Since it is unlikely that all entities engaged in electronic information transfers will purchase the same electronic system with the same digital certificates, any solution that enters the marketplace must be able to interoperate with others. In other words, any entity must be able to choose the system that meets their needs while allowing them to communicate to other suppliers and partners that have made other choices. An open systems solution is needed to enable interoperability.

Accordingly, there is a need for a method and system for authenticating and certifying electronic data transfers, thereby protecting the security and privacy of transmitted information. There is also a need for a method and system that provides non-tamperability and interoperability with other systems. Additionally, there is a need for a method and system that provides a cost-effective way to integrate the required standards into existing systems within a mandated timeframe.

### SUMMARY OF THE INVENTION

The present invention provides a method and system for authenticating and certifying electronic data transfers. The present invention is essentially a PKI-based interoperability toolkit. The present invention provides authenticity, integrity, secrecy and auditability (non-repudiation) for electronic data transfers. This toolkit will equip HCP's with a mechanism to bring their existing legacy and patient care computer systems up to date with HIPAA's new legal standards. It will also serve as the new standard vehicle for communication between providers while integrating customized public key concepts and techniques. The present invention accomplishes this in an extremely cost-effective manner.

In addition, the present invention is an open-systems based technology. As a result, it will interoperate with all mainstream issuers and re-issuers of digital certificates (PKI technology) in the market today. And because PKI technologies are currently the only fully accepted technological approach to providing non-repudiation and secure transactions by the Department of Health and Human Services (“HHS”), the present invention is soundly based on accepted and proven leading-edge technologies.

By using PKI technology and providing document/prescription validation, verification and non-repudiation capabilities, the present invention delivers a whole product solution. This is because the present invention meets the need for electronic data transfers to have authentication (verification), integrity (non-tamperability), secrecy (privacy and security) and, finally, a legal-grade digital receipt (audit trail and non-repudiation). Further, the present invention introduces a combination of electronically signed and secured documents, such as prescriptions from the doctor to the pharmacist, that can be transmitted numerous ways, such as over the Internet, by wireless communications, through personal digital assistants (“PDA's”), by virtual private network (“VPN”), through a closed network, or any combination thereof. The present invention offers secure non-repudiated transactions while allowing for interoperability and interface capability within existing legacy systems.

The present invention provides a comprehensive solution for electronically signing and delivering electronic documents in a secure environment while using digital certificates. The present invention enables HIPAA compliance in healthcare industry legacy environments. This is accomplished by focusing all product and service capabilities to address the following needs:

Deliver prescriptions electronically to pharmacies from physicians within a series of digitally validated and legally signed transaction events.

Offer cost effective technology that can be afforded and quickly adopted by Independent HCP's.

Insure each transaction event meets HIPAA guidelines for patient confidentiality and security.

Utilize HHS recommended PKI technology.

Provide for the creation and future reference of audit trails that are comprised of complete histories of all healthcare/prescription related transactions for each medical professional. (as required by HHS).

Offer complete and legal grade digital receipts (non-repudiation) on all transactions that contain patient information.

Insure that all transmitted patient information and records are non-tamperable, thus ensuring the integrity of data.

The need for increased precautions is not unique to the healthcare industry. Electronic transaction (eCommerce) reliability can be increased by the incorporation of the present invention. The present invention supplies an interoperable and open systems architecture resulting in a simple and cost-effective solution that provides many benefits, such as:

Significant reduction in transaction errors.

Increased confidentiality, integrity and security.

Non-repudiation of transactions.

Authentication of transactions.

Validation of transactions.

The present invention, therefore, provides a method and computer program for authorizing an electronic data transfer. An authentication request containing a digital certificate is received from a requesting device via a communication link. The present invention then determines whether the digital certificate is valid, and creates an authentication response denying the authentication request when the digital certificate is not valid, or approving the authentication request when the digital certificate is valid. The authentication response is then sent to the requesting device via the communication link, and information about the electronic data transfer, the digital certificate and at least a portion of the authentication response are stored.

The present invention also provides a method and computer program for authorizing an electronic data transfer comprising that receives an authentication request containing a digital certificate and information about the electronic data transfer from a requesting device via a communication link, and then determines whether the digital certificate is valid. The present invention then creates an authentication response denying the authentication request when the digital certificate is not valid, or approving the authentication request when the digital certificate is valid. The authentication response is then sent to the requesting device via the communication link. In addition, a digital receipt is created for the electronic data transfer when the digital certificate is valid. Information about the electronic data transfer, the digital certificate and at least a portion of the authentication response is also stored.

In addition, the present invention provides a system for authorizing an electronic data transfer that includes a computer, a data storage device communicably linked to the computer, and a requesting device communicably linked to the computer. The computer receives an authentication request containing a digital certificate from the requesting device, determines whether the digital certificate is valid, creates an authentication response denying the authentication request when the digital certificate is not valid, or approving the authentication request when the digital certificate is valid, sends the authentication response to the requesting device, and stores information about the electronic data transfer, the digital certificate and at least a portion of the authentication response on the data storage device.

Moreover, the present invention provides a system for authorizing an electronic data transfer including a computer, a data storage device communicably linked to the computer, and a requesting device communicably linked to the computer. The computer receives an authentication request containing a digital certificate and information about the electronic data transfer from the requesting device, determines whether the digital certificate is valid, creates an authentication response denying the authentication request when the digital certificate is not valid, or approving the authentication request and creating a digital receipt for the electronic data transfer when the digital certificate is valid, sends the authentication response to the requesting device, and stores the information about the electronic data transfer, the digital certificate and at least a portion of the authentication response on the data storage device.

### BRIEF DESCRIPTION OF THE DRAWINGS

The above and further advantages of the present invention may be understood by referring to the following description in conjunction with the accompanying drawings in which corresponding numerals in the different figures refer to the corresponding parts in which:

FIG. 1 depicts a block diagram of an overall system in accordance with the present invention;

FIG. 2 depicts a flow diagram of an overall system in accordance with the present invention;

FIG. 3 depicts a flow diagram of an alternative overall system in accordance with the present invention;

FIG. 4 depicts the connectivity of a prescription system in accordance with the present invention;

FIG. 5 depicts a flow diagram of a prescription system in accordance with the present invention;

FIG. 6 depicts a flow diagram of an alternative prescription system in accordance with the present invention;

FIG. 7 depicts the connectivity of an alternative overall system in accordance with the present invention;

FIG. 8 depicts a flow diagram of an alternative overall system in accordance with the present invention;

FIG. 9 depicts a flow diagram of an alternative overall system in accordance with the present invention;

FIG. 10 depicts an illustration of a web-based screen representing a physician's home folder in accordance with the present invention;

FIG. 11 depicts an illustration of a web-based screen representing a listing of possible pharmacies in accordance with the present invention;

FIG. 12 depicts an illustration of a web-based screen representing a listing of possible prescriptions sent by a specific doctor to a specific pharmacy on a specific day in accordance with the present invention;

FIG. 13 depicts an illustration of a web-based screen representing a document selection screen in accordance with the present invention;

FIG. 14 depicts an illustration of a web-based screen representing an ePrescription in accordance with the present invention;

FIG. 15 depicts an illustration of a web-based screen representing a pharmacist's upload directory in accordance with the present invention;

FIG. 16 depicts an illustration of a web-based screen representing the full details of an ePrescription in accordance with the present invention;

FIG. 17 depicts an illustration of an internal use embodiment in accordance with the present invention;

FIG. 18 depicts an illustration of an external use embodiment in accordance with the present invention;

FIG. 19 depicts an alternative data flow in accordance with the present invention; and

FIG. 20 depicts another alternative data flow in accordance with the present invention.

### DETAILED DESCRIPTION OF THE INVENTION

While the making and using of various embodiments of the present invention are discussed herein in terms of a HIPAA compliant document system and method, it should be appreciated that the present invention provides many applicable inventive concepts that can be embodied in a wide variety of specific contexts. The specific embodiments discussed herein are merely illustrative of specific ways to make and use the invention and are not meant to limit its scope in any way.

In one application, the present invention can be characterized as a HIPAA compliance toolkit This new technology is versatile and flexible enough that it can be integrated into almost any legacy environment and into most critical business software applications. This is due in part to the extensible Markup Language (“XML”) based technology that is employed within the present invention. The present invention can be operated in a closed systems environment (i.e., VPN), via dedicated communication lines or it can utilize the openness and benefit of the Internet to accomplish its purpose.

More specifically, the present invention addresses the verification, validation and non-repudiation requirements of HIPAA. Non-repudiation means that there is a “legal grade” digital receipt that provides strong and substantial evidence that will make it difficult for the signer to claim that the electronic representation is not valid. The present invention causes all ePrescription “documents” to be electronically signed, sent and securely received across the Internet or within private networks, such as VPN's. The present invention also creates a “legal-grade” digital receipt of these electronic transactions and stores them into a digital vault for possible future reference. This feature not only helps HCP's meet the extremely high legal standard known as “irrefutable entity authentication,” but it provides the basis for an audit trail of electronic transactions.

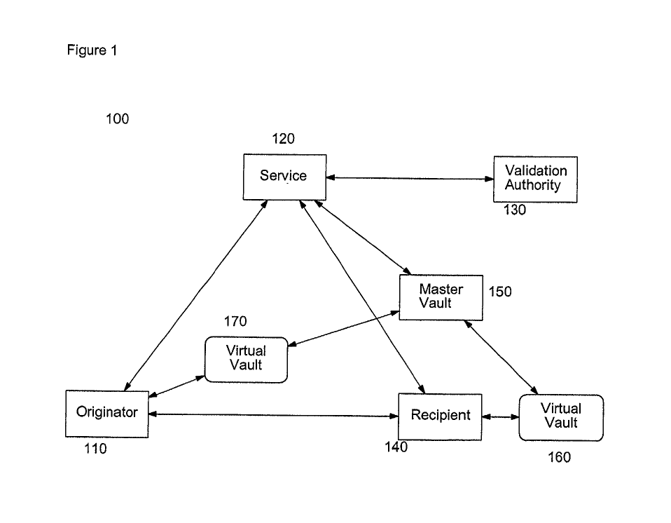

Turning to FIG. 1, a block diagram of an overall system 100 in accordance with the present invention is shown. The system 100 includes an originator 110, an authorization service 120, a validation authority 130 and a recipient 140. The originator 110 can be a HCP, such as a doctor, hospital or pharmacy, or any other person or entity that desires to send electronic information to the recipient 140. Similarly, the recipient 130 can be an HCP, such as a doctor, hospital or pharmacy, or any other person or entity that desires to receive electronic information from the originator 110. The service 120 can be any entity that provides authentication and certification services to the originator 110 and/or recipient 120, thereby enabling non-repudiation data transfers. The validation authority 130 is any entity that can verify whether or not a digital certificate is valid.

The system 100 also includes one or more data repositories or vaults 150, 160 or 170 that store the information necessary to establish non-repudiation for the data transfers. FIG. 1 illustrates one possible vault configuration. Originator 110 is authorized through service 120 prior to transmitting electronic data, such as a document, patient information, financial information or business transaction. Originator 110 may request that authorization in a number of ways. For example, originator 110 may swipe a card containing the digital certificate of originator 110. Originator 110 may also use a personal log-on or a combination of a card and a logon. Biometrics may also be used to verify the identity of the originator 110.

Originator 110 may be able to request authorization on a transfer-by-transfer basis or in a “batch” mode. For the “batch” mode, the authorization of originator 110 may be requested once, then cached or stored by service 120, in random access memory (“RAM”) or on a server (local or remote) for use on multiple transfers. Each transfer would receive individual time/date stamps from service 120. Another alternative would be for originator 110 to log-on and create multiple electronic documents or data messages, possibly saving each. Then, originator 110 would request authorization from service 120 prior to transmitting the multiple electronic documents. Again, each electronic document would receive individual time/date stamps from service 120. Sub-ID's may also be used for those working under the direction and/or authority of originator 110. Transfer authorizations would still be determined through an examination of the digital certificate of originator 110.

Service 120 validates the authorization request with validation authority 130 and then, if authorization is granted, stores a record of the digital certificate of originator 110 with a date and time stamp in master vault 150 and allows originator 110 to complete the transmission. If, however, authorization is not granted, service 120 notifies the originator 110 that authorization has been denied and records relevant information about the request, such as the digital certificate, a date/time stamp and the reasons for denial, in master vault 150. This provides another aspect of the audit trail. Originator 110 creates and sends the transmission to recipient 140 using software that allows only the explicitly intended recipient to read the contents of the transmission. Contents of the transmission are stored in virtual vault 170 as related to the previously stored digital certificate. Transmission contents may also be stored in master vault 150, either through service 120 or through virtual vault 170. Virtual vault 170 may be hosted by service 120, on a server internal to the organization of originator 110 or on a server external to the organization of originator 110. Alternatively, master vault 150 may contain transaction data, transaction identification numbers, or have pointers referring to specific records in virtual vault 170.

The transmission arrives at recipient 140 where it is stored in a queue in virtual vault 160 until opened by recipient 140. Prior to opening the transmission, recipient 140 requests authorization through service 120. Recipient 140 may request that authorization in a number of ways. For example, recipient 140 may swipe a card containing the digital certificate of recipient 140. Recipient 140 may also use a personal log-on or a combination of a card and a log-on. Service 120 validates the authorization request with validation authority 130 and then, if authorization is granted, stores a record of the digital certificate of recipient 140 with a date and time stamp in virtual vault 150 as related to the transmission and allows recipient 140 to open the transmission. Transmission contents may also be stored in master vault 150, either through service 120 or through virtual vault 160. Virtual vault 160 may be hosted by service 120, on a server internal to the organization of recipient 140 or on a server external to the organization of recipient 149. Alternatively, master vault 150 may contain transaction data, transaction identification numbers, or have pointers referring to specific records in virtual vault 160. A transmission notification may also be sent from recipient 140 to originator 110. This transmission notification may include information related to who responded to the transmission and further actions taken related to the transmission.

When applied to the healthcare industry, the present invention enhances patient care and meets the HIPAA compliance standards by authenticating the identity of the physician and the pharmacist, insuring that the document has not been altered (non-tamperability), validating the transaction of the prescription document with a date, time and action stamp, and developing an audit trail and thus assuring legally binding non-repudiation. Together, these four (4) factors provide the legally binding electronic signature on the “non-refutable” ePrescription document. In addition, the present invention can provide other related services, such as transaction services, hosting/vaulting Services, professional services and auditing services.

Transaction services would operate in either of the following ways: ePrescription transactions flowing directly through hosting equipment, or ePrescription transactions and blocks of transactions sold to entities using the present invention within their own environments and flowing through their own equipment.

A personal computer, web browser and a connection to the Internet are essentially all that are required by the end user to use the present invention.

Hosting and Vaulting Services are directed at one of the three following categories of customers:

1. Those that are “too small” to afford (i) costly hosting servers, (ii) firewalls and backup devices, or (iii) the personnel required to operate such a large scale data center.

2. Those that do not want to the hassles of keeping such a data center operational twenty-four hours a day, seven days a week, three hundred sixty five days a year.

3. Those that are required by law to have a trusted third party (e.g. Independent Notary) store and maintain their patient related data transactions.

It the first two (2) categories are predominantly comprised of small and medium sized HCP's. That is, unless respective State laws required that no third party be authorized storage of patient related information. In such cases, these entities can integrate the present invention into their own environments. Regarding the third category, currently, most states disallow a third party to receive transaction information between a physician and a pharmacist. However, because of HIPAA and the requirement to have non-tamperable audit trails, States are expected to begin changing their laws to accommodate the emergence of “Trusted Third Party Notaries” that will maintain and store this sensitive data.

This is especially logical when one considers the potential conflict of interest that exists when HCP's are charged with maintaining their own data. Consider for example, that under HIPAA, every HCP (or its employees) are required to turn themselves in for all HIPAA related infractions. Because departmental or organizational individuals can be criminally or civilly charged with fines and jail time for HIPAA non-compliance, some experts argue that the temptation might exist to possibly eliminate incriminating audit trails or digital receipts. Thereby eliminating the entire reason for having them. Therefore, the need exists for the more cautious approach of independent and “Trusted Third Party Notaries.” Hosting/vaulting services will be sought out by those with restrictive budgets and by those that are required to do so by law.

The present invention preferably uses PKI technology to provide secure data transfers. Although other industry accepted encryption techniques can be used, PKI is the preferred encryption technology at this time because it has been adopted by HIPAA. Moreover, the present invention compliments PKI technologies and addresses the portions of HIPAA that PKI's design does not address. The present invention can be integrated into all existing ePrescription software products and in all hospital environments. It is also based upon physicians and pharmacists owning a digital certificate from an established Certificate Authority (“CA”). These digital certificates are used in conjunction with any software application that produces an electronic prescription document, enabling compliance with healthcare standards, such as NCPDP.

In addition, the present invention adopts an “Open-Systems” architectural approach. Thus, it easily interfaces with existing and already accepted/integrated mainstream PKI technologies. As noted above, the present invention is based in part upon XML standards. Thus, it can easily be designed to interface with a wide range of existing legacy systems and software products. Such an open systems approach differentiates itself from traditional methods of market dominance and encourages others to employ the technology of the present invention into their own. Further, this makes it more scaleable and easier to “adopt” than other proprietary approaches that might be considered.

Also along the lines of interoperability is the present invention's ability to interface with all existing major brands of digital certificates. In the past, lack of interoperability has slowed acceptance of superior PKI based technologies. As a result, it was once necessary for a business to purchase all of the same digital certificates that all of its vendors and suppliers possessed. This is both complex and expensive. In response, the present invention breaks down this significant barrier by bridging the industry together with its interoperable approach.

As a result, entities no longer have to purchase every brand of major digital certificates to conduct authenticated electronic transactions with their vendors and suppliers. Simply by embedding the present invention into their existing technologies and environments, entities will now only have to purchase one (1) brand of digital certificate. If desired, their suppliers and vendors can continue utilizing whatever brand of certificate that they choose. Not only are the costs significantly reduced by no longer being required to purchase many different digital certificates for each critical employee, but less complex systems and interfaces can be developed.

Another area of concern addressed by the present invention lies within the Certificate Authorities (“CA's”). Such authorities are the current manufacturers and issuers of digital certificates that utilize the PKI technology. Currently, PKI technology only addresses a portion of the legal requirements associated with HIPAA and eSign compliance. More specifically this is Authenticity (verification). Entity Authentication (Verification) is the single greatest strength of PKI technologies. Of course, for this piece of HIPAA compliance to work, proper and full integration of this capability must be addresses into all healthcare applications containing or manipulating patient information.

Unfortunately, most applications today that take advantage of this feature do not record the ‘historical’ information related to each transaction as they occur (such as identity of person and the date & time verification occurred, etc.). They merely grant an individual access to a system or application—without preserving any of the legally required components related to their validation and verification into the system. The present invention records the legally required information related to the identity of the individual as well as the date and time that the verification occurred.

Arguably, PKI technology, and thus CA's in general, do not specifically address the three (3) remaining issues concerning: Integrity (non-tamperability); Secrecy (Privacy & Security); and Auditability/Audit Trails (Vaulted Digital Receipts). The present invention maintains integrity by incorporating an encryption and hashing methodology into each of the recorded transaction files that it maintains. As a result, it is not only difficult to tamper with the data, but it is easy to determine if it has been altered. Privacy and Secrecy of patient information is well protected by the present invention. Because of the present invention's encryption and stringent recording of each component of every transaction, unauthorized access of patient information is more difficult and audit trails clearly show any violations of improperly shared or accessed patient information.

An electronic signature is nothing more than the unquestioned identity of an individual attached to a transaction (in the form of a digital certificate) with all corresponding dates, times and events that occurred as part of that transaction. As a result, electronic signatures can be used to satisfy HIPAA requirements. In addition, transactions based digital receipts should be vaulted for future reference (audits) and that they may not be altered without recognition. Finally, while PKI technology does serve as a useful tool that helps enable secrecy measures to be implemented, it is only the tool or vehicle to the “ends” and not the total solution capable of standing upon its own merit.

The present invention can equip the major CA's with its re-vamped healthcare related core engine technology. Not only would this be a more cost-effective option for the major CA's, but this would also give them speed to market and other advantages over their competitors. This would generate additional healthcare transactions that are verified, validated, and possibly vaulted. It would also help ensure immediate “Standards-Based” interoperability between the major CA's (another advantage to them).

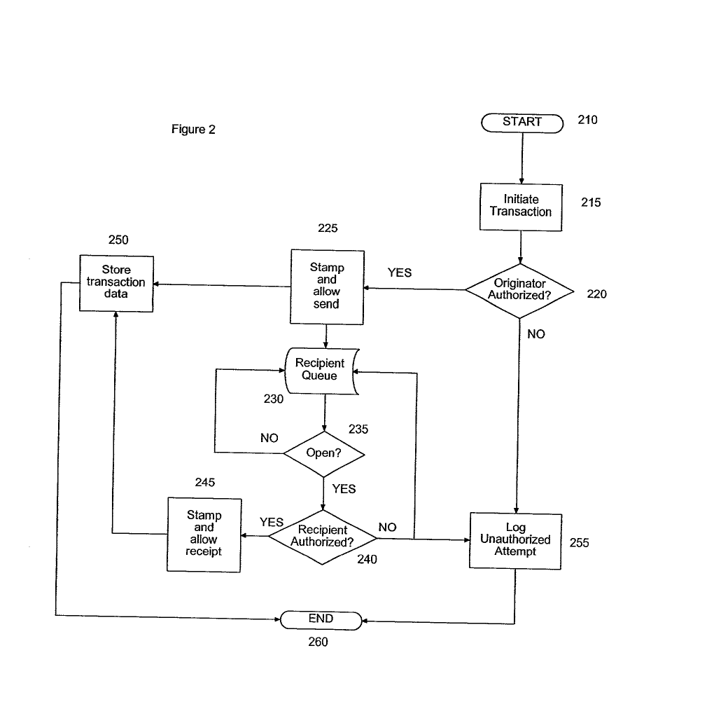

Now referring to FIG. 2, a flow diagram of an overall system in accordance with the present invention is shown. The system starts in block 210. A data transfer or transaction is initiated in block 215. Originator authorization is requested at decision point 220. If originator authorization is denied at decision point 220, the unauthorized attempt is logged at block 255 and the flow stops at block 260. If originator authorization is granted at decision point 220, a validation stamp is created in block 225 and stored with transaction data in block 250, ending in block 260. At the same time, the transaction send is allowed in block 225 to commence to recipient queue 230. While the transaction remains unopened at decision point 235, the transaction remains in recipient queue 230. Once the recipient attempts to open the transaction at decision point 235, recipient authorization is requested at decision point 240. If recipient authorization is denied at decision point 240, the unauthorized attempt is logged at block 255 and the flow stops at block 260. Additionally, if recipient authorization is denied at decision point 240, the transaction is returned unopened to recipient queue 230. If recipient authorization is granted at decision point 240, a validation stamp is created and the recipient is allowed to view the transaction in block 245. The validation stamp created in block 245 is then stored in block 250 with the transaction data and the validation stamp created in block 225. The system then terminates at block 260.

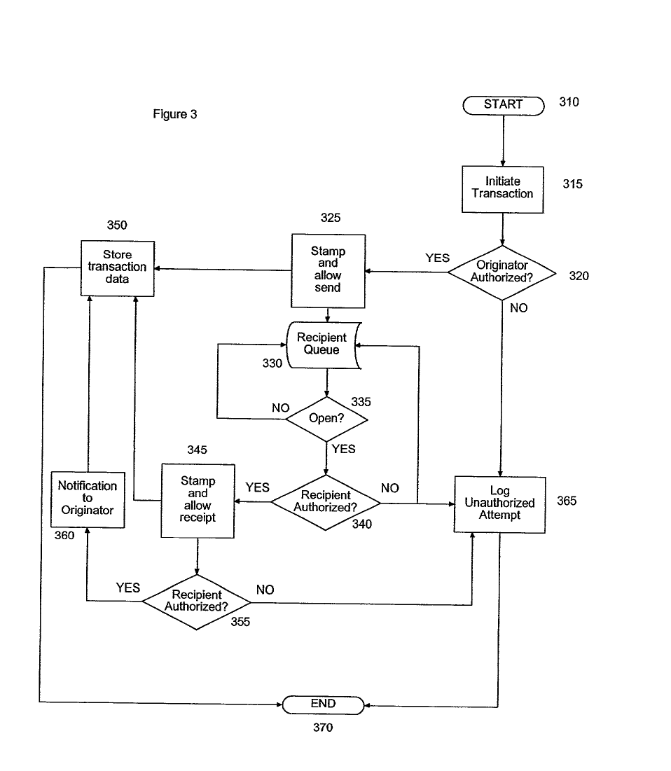

FIG. 3 depicts a flow diagram of an alternative overall system in accordance with the present invention. The system starts in block 310. A data transfer or transaction is initiated in block 315. Originator authorization is requested at decision point 320. If originator authorization is denied at decision point 320, the unauthorized attempt is logged at block 365 and the flow stops at block 370. If originator authorization is granted at decision point 320, a validation stamp is created in block 325 and stored with transaction data in block 350, ending in block 370. At the same time, the transaction send is allowed in block 325 to commence to recipient queue 330. While the transaction remains unopened at decision point 335, the transaction remains in recipient queue 330. Once the recipient attempts to open the transaction at decision point 335, recipient authorization is requested at decision point 340. If recipient authorization is denied at decision point 340, the unauthorized attempt is logged at block 365 and the flow stops at block 370. Additionally, if recipient authorization is denied at decision point 340, the transaction returns to recipient queue 330. If recipient authorization is granted at decision point 340, a validation stamp is created and the recipient is allowed to view the transaction in block 345. The validation stamp created in block 345 is then stored with the transaction data and the validation stamp created in block 325 in block 350. After the validation stamp is created and the recipient is allowed to view the transaction in block 345, the recipient can again request recipient authorization at decision point 355. If recipient authorization is denied at decision point 355, the unauthorized attempt is logged at block 365 and the flow stops at block 370. If recipient authorization is granted at decision point 355, the recipient may then send notification to the originator in block 360. Information related to the notification sent to the originator in block 360 may then be stored in block 350 with the transaction data, the validation stamp created in block 325 and the validation stamp created in block 345. The system then terminates at block 370.

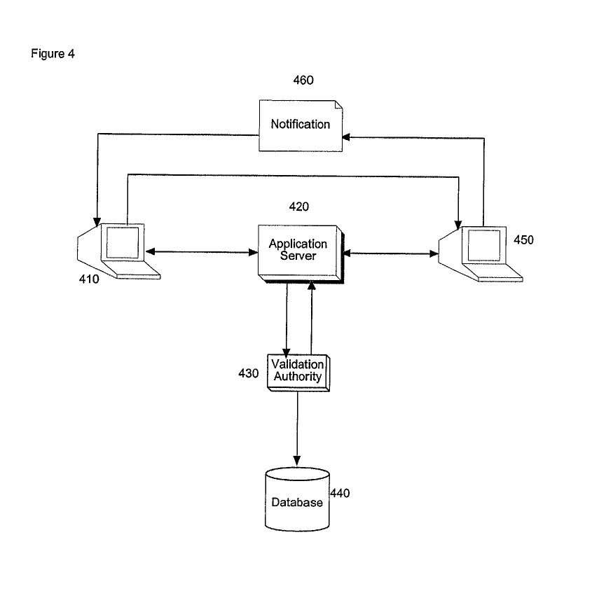

FIG. 4 depicts the connectivity of a prescription system in accordance with a preferred embodiment of the present invention. A physician provider initiates an ePrescription at 410. Each physician provider will use web based client software or a third party hand-held based application (such as iScribe or PocketScript), which will produce the ePrescription document. Application server 420 provides the ability to verify authorization through validation authority 430 and store ePrescription-related data in database 440. The document (with the accompanying digital certificate uniquely identifying the physician) will be sent to the pharmacy destination of choice 450. The pharmacist at 450 will receive an electronic notification that a new prescription has arrived. Using a uniquely assigned digital certificate, the pharmacist will be validated into the system through application server 420 and validation authority 430. If the pharmacist possesses a valid digital certificate, the ePrescriptions will be retrieved and stored onto the pharmacist's computer. Upon opening each prescription in his queue, a date and time stamp will be placed on each ePrescription document noting that that specific pharmacist has opened it. Alternatively, authorization may be made on a pharmacy level. In that case, each opened ePrescription document would receive a note that a specific pharmacy had opened it. The digital receipt may include the date, time, identity of the pharmacist, identity of the prescribing physician and the action taken (i.e. prescribing and acceptance of a prescription in this case). This is also stored in database 440.

Upon the acceptance of the prescription, the pharmacist would then fill the medication as requested. Later, after the patient receives their prescription, the pharmacist would again request validation through application server 420 and validation authority 430 and indicate that the prescription had been filled according to the terms stated. Also, a notification 460 can be sent from pharmacy 450 to physician 410 indicating that the ePrescription has been filled and the patient has picked-up the medication. If the physician's or pharmacist's digital certificate has been revoked or if the document has been altered before being received by the pharmacist, or after filling the prescription, log entries would be made to record these events. The physician would not be allowed to transmit the prescription if his/her digital certificate had been revoked. The pharmacist would not be allowed to view the prescription if his/her digital certificate had been revoked. Thus, the integrity of the data and of the information contained within it is preserved.

Application server 420 can be any server capable of running the necessary software to conduct the ePrescription transaction; an example would be a Proxymed server. Additionally application server 420 may host storage databases. The present invention provides an infrastructure for interfacing with the software running on application server 420. The present invention supplies the authentication, validation, certification and integrity checks needed to meet the required standards. Application program interface (“API”) routines enable communication between the prescription software and the present invention.

The present invention also significantly reduces the likelihood of transaction errors by providing secure readable electronic documents from the sender to the receiver, such as an ePrescription from a doctor to a pharmacist. The present invention insures that the prescription came from the physician author, thereby reducing the risk of fraud or duplication of the prescription by the patient.

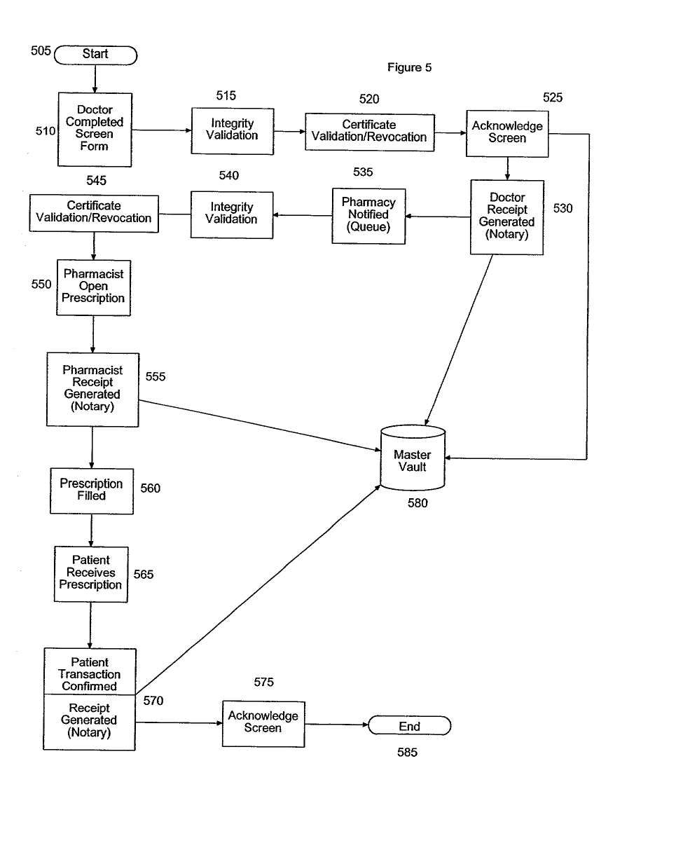

FIG. 5 depicts a flow diagram of a prescription system in accordance with the present invention. The system starts in block 505. The doctor completes the screen form in block 510. Integrity validation on the prescription is performed in block 515. The validity (i.e., existence and revocation status) of the doctor's digital certificate is performed in block 520. Once authorization is received, the doctor is presented with an acknowledgement screen in block 525. The prescription that the doctor created is then stored/vaulted in master vault 575 to await access by the pharmacist. A receipt recording the doctor's transaction is generated at block 530 and stored in master vault 575. An electronic notification notifies the pharmacy in block 535 that a prescription has arrived. Before the pharmacist can open the prescription, integrity validation on the prescription is performed in block 540. The validity (i.e., existence and revocation status) of the physician's digital certificate is performed in block 545. The pharmacist opens the prescription in block 550. A receipt recording the pharmacist's actions is generated in block 555 and stored in master vault 580. The pharmacist then fills the prescription in block 560. The patient receives the prescription in block 565. The patient transaction is confirmed and a receipt generated in block 570. The receipt is stored in master vault 580. An acknowledgement screen is displayed to the pharmacist in block 575. The system then terminates at block 585.

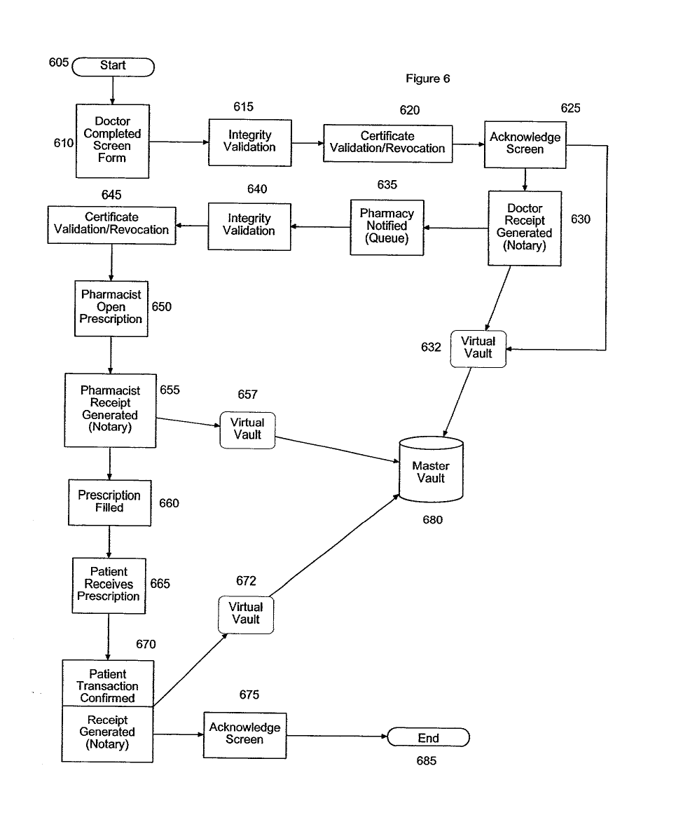

FIG. 6 depicts a flow diagram of an alternative prescription system in accordance with the present invention. The system starts in block 605. The doctor completes the screen form in block 640. Integrity validation on the prescription is performed in block 615. The validity (i.e., existence and revocation status) of the doctor's digital certificate is performed in block 620. Once authorization is received, the doctor is presented with an acknowledgement screen in block 625. The prescription that the doctor created is then stored/vaulted in virtual vault 632. The prescription is also sent to virtual vault 657 to await access by the pharmacist. A receipt recording the doctor's transaction is generated at block 630 and stored in virtual vault 632. An electronic notification notifies the pharmacy in block 635 that a prescription has arrived. Before the pharmacist can open the prescription, integrity validation on the prescription is performed in block 640. The validity (i.e., existence and revocation status) of the physician's digital certificate is performed in block 645. The pharmacist opens the prescription in block 650. A receipt recording the pharmacist's actions is generated in block 655 and stored in virtual vault 657. The pharmacist then fills the prescription in block 660. The patient receives the prescription in block 665. The patient transaction is confirmed and a receipt generated in block 670. The receipt is stored in virtual vault 672. An acknowledgement screen is displayed to the pharmacist in block 675. The system then terminates at block 685. The data stored in virtual vault 632, virtual vault 657 and virtual vault 672 contains unique identifiers indicating the relationship between the data in each virtual vault. The data may then be “trickled down” to master vault 680.

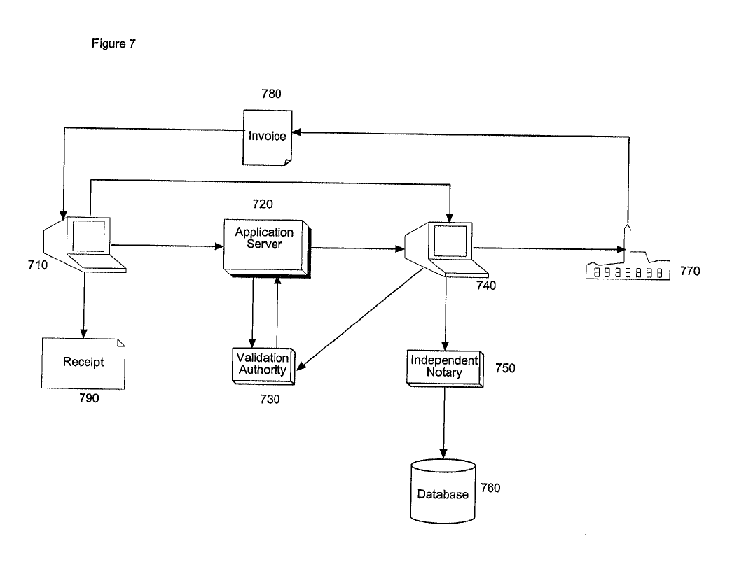

FIG. 7 depicts the connectivity of an alternative overall system in accordance with a preferred embodiment of the present invention. A purchaser at 710 initiates an eCommerce transaction. The transaction passes through application server 720 thereby enabling identity and state validation by accessing validation authority 730. The transaction is stamped, passed back to application server 720 and sent to seller 740. Prior to accessing the eCommerce transaction, seller 740 also requires validation and authorization from validation authority 730. Seller 740 generates a transaction confirmation that is then notarized by Independent Notary 750 and subsequently stored in database 760, a receipt vault maintained by Independent Notary 750. Seller 740 also generates a shipping order that is sent to manufacturer/supplier 770. Manufacturer/supplier 770 fulfills the eCommerce requests and sends invoice 780 and the order back to purchaser 710. Purchaser 710 then submits payment to seller 740. Purchaser 710 and/or seller 740 can later review the transaction confirmation through a web-based receipt center 790.

Application server 720 can be any server capable of running the necessary software to conduct the eCommerce transaction. Additionally application server 720 may host storage databases. The present invention provides an infrastructure for interfacing with the software running on application server 720. The present invention supplies the desired authentication, validation, certification and integrity checks. Application program interface (“API”) routines enable communication between the software and the present invention.

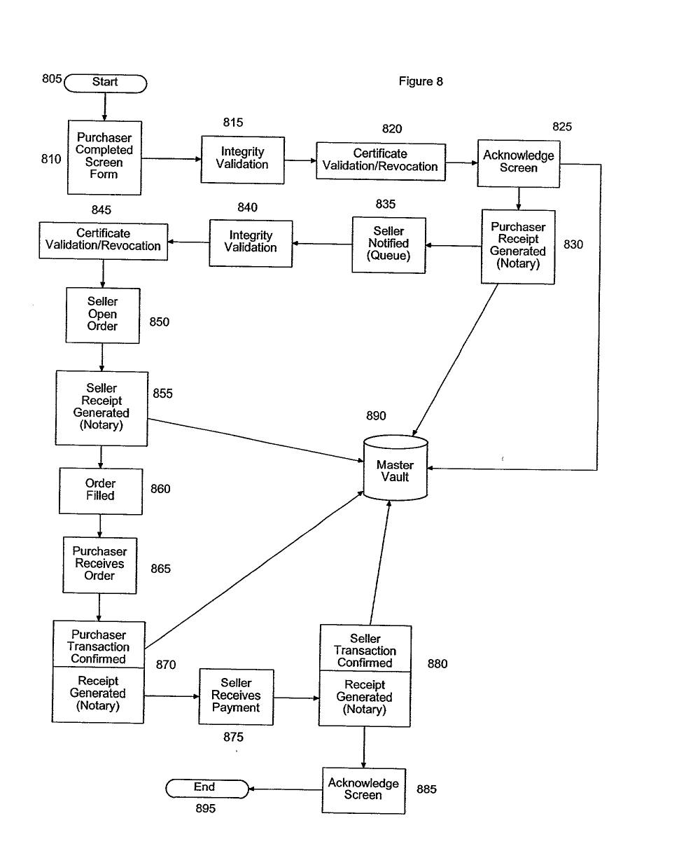

FIG. 8 depicts a flow diagram of an alternative overall system in accordance with the present invention. The system starts in block 805. The purchaser completes the screen form in block 810. Integrity validation on the electronic document is performed in block 815. The validity (i.e., existence and revocation status) of the purchaser's digital certificate is performed in block 820. Once authorization is received, the purchaser is presented with an acknowledgement screen in block 825. The order that the purchaser created is then stored/vaulted in master vault 890 to await access by the seller. A receipt recording the purchaser's transaction is generated at block 830 and stored in master vault 890. An electronic notification notifies the seller in block 835 that an order has arrived. Before the seller can open the order, integrity validation on the electronic document is performed in block 840. The validity (i.e., existence and revocation status) of the seller's digital certificate is performed in block 845. The seller opens the order in block 850. A receipt recording the seller's actions is generated in block 855 and stored in master vault 890. The seller then fills the order in block 860. The purchaser receives the order in block 865. The purchaser transaction is confirmed and a receipt generated in block 870. The receipt is stored in master vault 890. The seller then receives payment for the order in block 875. The seller transaction is confirmed and a receipt generated in block 880. The receipt is stored in master vault 890. An acknowledgement screen is displayed to the seller in block 885. The system then terminates at block 895.

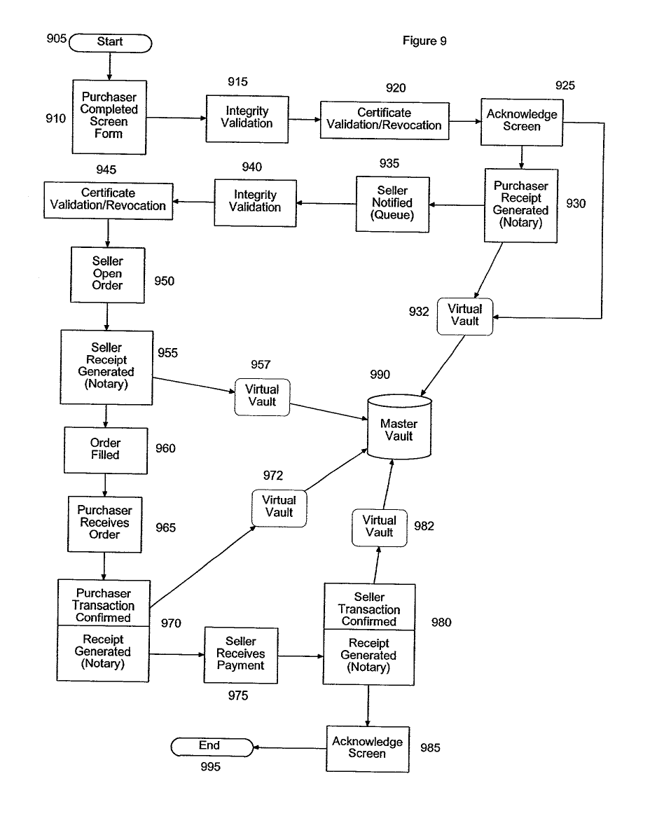

FIG. 9 depicts a flow diagram of an alternative overall system in accordance with the present invention. The system starts in block 905. The purchaser completes the screen form in block 940. Integrity validation on the electronic document is performed in block 915. The validity (i.e., existence and revocation status) of the purchaser's digital certificate is performed in block 920.

Once authorization is received, the purchaser is presented with an acknowledgement screen in block 925. The electronic document that the purchaser created is then stored/vaulted in virtual vault 932. The electronic document is also sent to virtual vault 957 to await access by the seller. A receipt recording the purchaser's transaction is generated at block 930 and stored in virtual vault 932. An electronic notification notifies the seller in block 935 that an electronic document has arrived.

Before the seller can open the electronic document, integrity validation on the electronic document is performed in block 940. The validity (i.e., existence and revocation status) of the purchaser's digital certificate is performed in block 945. The seller opens the electronic document in block 950. A receipt recording the seller's actions is generated in block 955 and stored in virtual vault 957. The seller then fills the order in block 960. The purchaser receives the order in block 965. The purchaser transaction is confirmed and a receipt generated in block 970. The receipt is stored in virtual vault 972. The seller then receives payment for the order in block 975. The seller transaction is confirmed and a receipt generated in block 980. The receipt is stored in virtual vault 982. An acknowledgement screen is displayed to the seller in block 985. The system then terminates at block 995. The data stored in virtual vault 932, virtual vault 957, virtual vault 972 and virtual vault 982 contains unique identifiers indicating the relationship between the data in each virtual vault. The data may then be “trickled down” to master vault 990.

By being a “trusted” and independent keeper of all electronic transaction information, the present invention can function as an Independent Notary.

Independent attestment gives more legal credibility to the fact that a transaction occurred as reported. Especially as one considers potential conflicts of interest, such as when a doctor, hospital executive or pharmacist might be required to research and present data that could be construed as incriminating against themselves or to their respective organizations. Without trusted and independent notaries, potentially incriminating data could be “accidentally lost” to avoid facing severe civil and criminal charges. Thus, further casting legal concerns and shadows on the reliability of the privately held vaulted data.

Another side benefit is that this “trusted notary” stature reduces the present invention's liability in the doctor-pharmacist transaction processes. By taking such a role, the present invention merely functions as a “historic reporter” of the information and transactions that were generated, not an active player or “referee” of all transactions between parties.

In cases where a client or State law mandates that information be stored in private vaults, the present invention would not function as a notary. In these instances the technology, integration services and transaction “clicks” enable an entity to become HIPAA compliant. Thus, they could vault the data within their own facilities as dictated by their company policy or respective State laws.

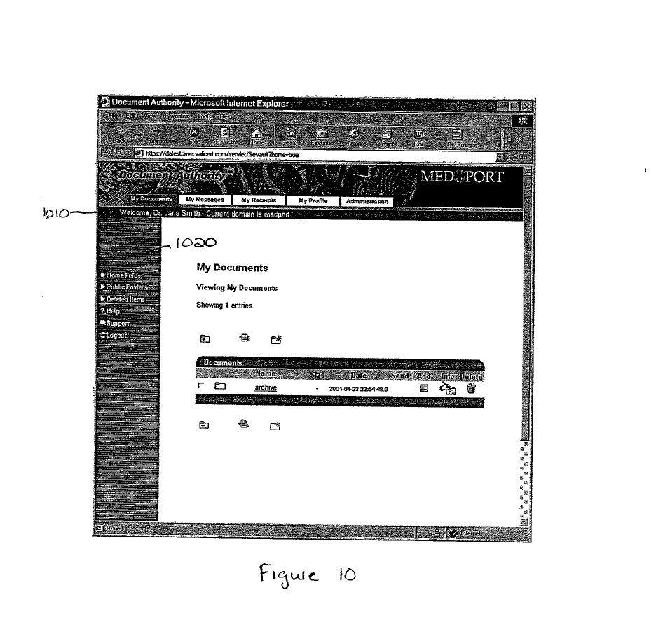

Three (3) different types of customer categories can be served by the present invention: web browser-based customers, integrated systems customers, and software development manufacturers. Web browser-based customers interact directly with the present invention's proprietary entry screens. This model allows Customers to quickly incorporate the benefits of the present invention into their existing systems without making modifications to their existing systems. FIGS. 10 through 16 illustrate web-based screens depicting an example ePrescription transaction.

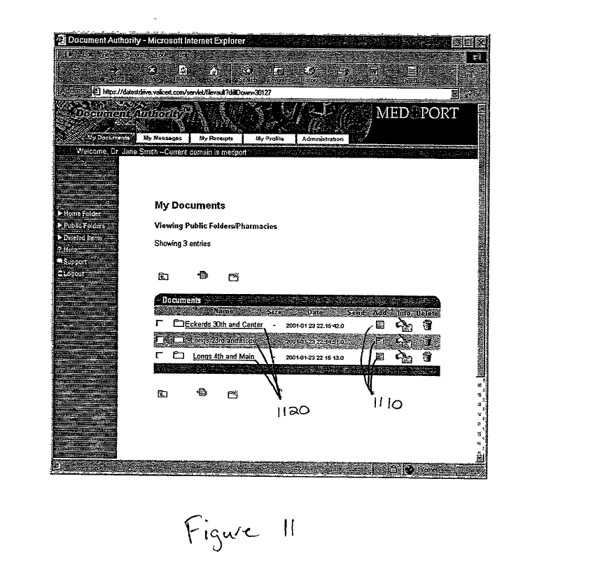

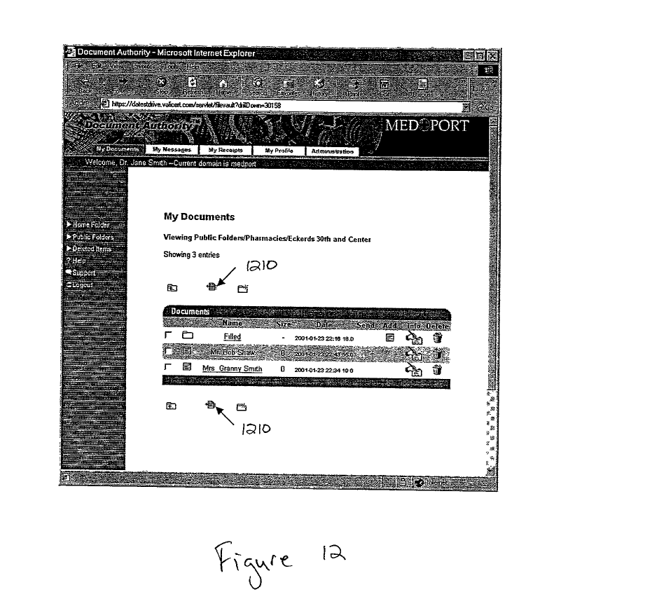

After authenticating through the present invention using either username/password and/or smart cards, the physician is presented with his/her own home directory, FIG. 10. Status bar 1010 indicates the name of the physician. To create a new ePrescription, the doctor navigates to the corresponding pharmacy's home directory by clicking on the Public Folder item in bar 1020. This brings up the list of pharmacies, as in FIG. 11. At this point, the physician can click an Add button 1110 to create an ePrescription within corresponding pharmacy 1120 or click corresponding pharmacy 1120 to view any other prescriptions created by that physician for that day, as shown in FIG. 12. A given doctor will not be able to see any prescriptions created by other doctors.

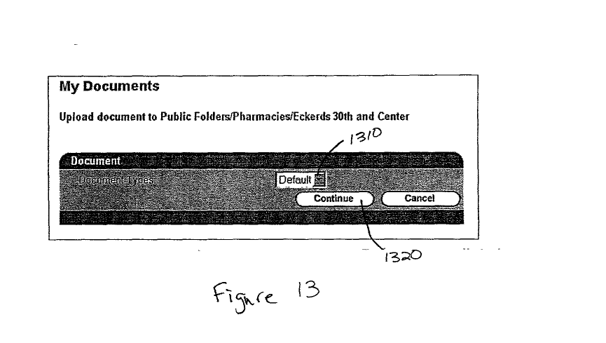

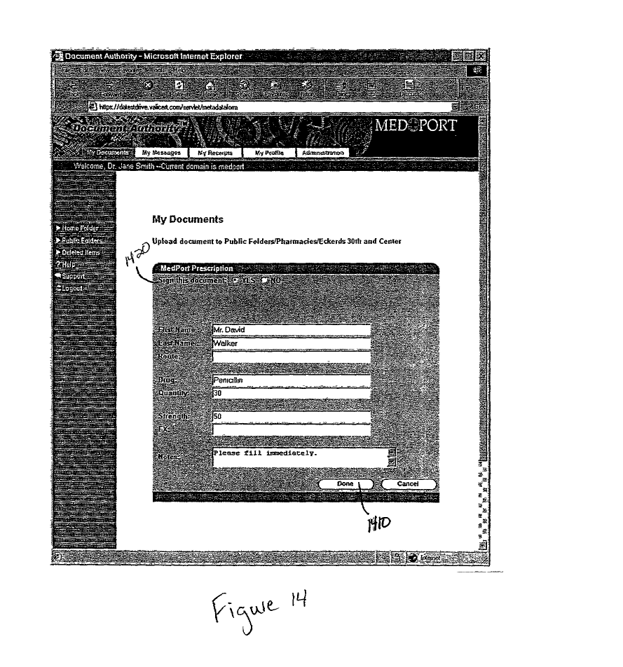

To create the ePrescription, the physician clicks new document button 1210, bringing up FIG. 13. FIG. 13 contains drop down selection box 1310. Selection box 1310 allows for the creation of different ePrescription types. Once continue button 1320 is clicked, the physician is presented with an ePrescription form as in FIG. 14. Initially, the ePrescription form will be blank.

Once the ePrescription form is completed and done 1410 is clicked, the ePrescription is signed using a smart card and browser-side plug-in. The signed ePrescription is then uploaded to the server and is immediately available to the pharmacists that have access to that pharmacy's ePrescription directory. Signing document 1420 will be mandatory for HIPAA compliance. At this point, the physician has completed creating the ePrescription and can logout or continue creating other ePrescriptions.

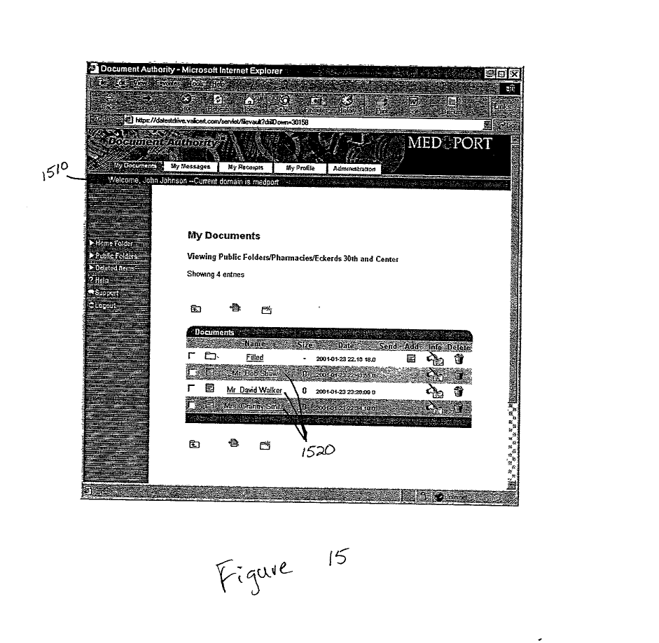

When the pharmacist logs onto the system, they see their pharmacy's ePrescription upload directory, FIG. 15. Status bar 1510 indicates the name of the pharmacist logged onto the system. The filled directory is similar to the physician's archive directory. Any ePrescription that is filled is moved into the filled directory at the end of each business day.

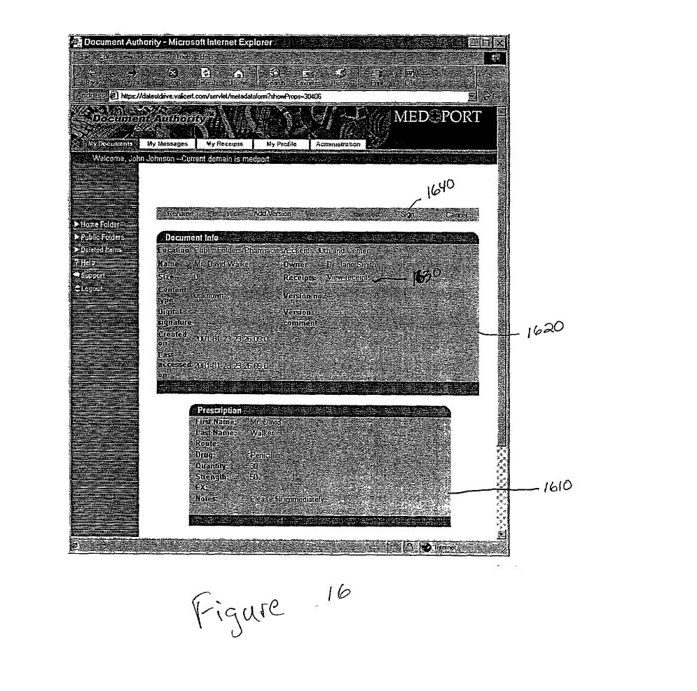

To select an ePrescription, the pharmacist clicks on the name of the ePrescription 1520 to bring up FIG. 16. FIG. 16 gives full details on the ePrescription. Bottom box 1610 contains all the information input into the ePrescription form by the physician. Top box 1620 shows information about the ePrescription captured by the present invention at the time of the document's creation. If more historical information is required, view receipts 1630 will show a list of all digital receipts for every action performed on this ePrescription, including creation, modifications or deletions. Once the ePrescription has been filled, the pharmacist clicks on sign 1640, triggering the browser-side signing plug-in. This certifies that the logged-on pharmacist has filled the ePrescription.

Integrated systems customers will have an existing documentation system (on the originator's side) or an automated dispensing system (on the supplier/vendor side). Under this model, the customer's existing systems will need to be connected to the present invention's “pipe” to provide them access to the present invention's technologies. Retail pharmacy chains are an example of a customer likely to be interested in this model.

Currently, iScribe is distributing their hand-held devices (e.g. Palm Pilot® and CE® devices) to physicians in key markets at no cost to the physician. This provides the doctors a cost effective and very good electronic prescription device. However, it is not presently a HIPAA compliant method in which to prescribe patient medications. After integrating the present invention's technology into iScribe's, both parties win. An increased number of HCP's are immediately able to become HIPAA compliant with little to no additional effort. iScribe wins because they have a competitive and immediate jump on their competitors by being HIPAA compliant. Their cost and effort to achieve compliance is minimal.

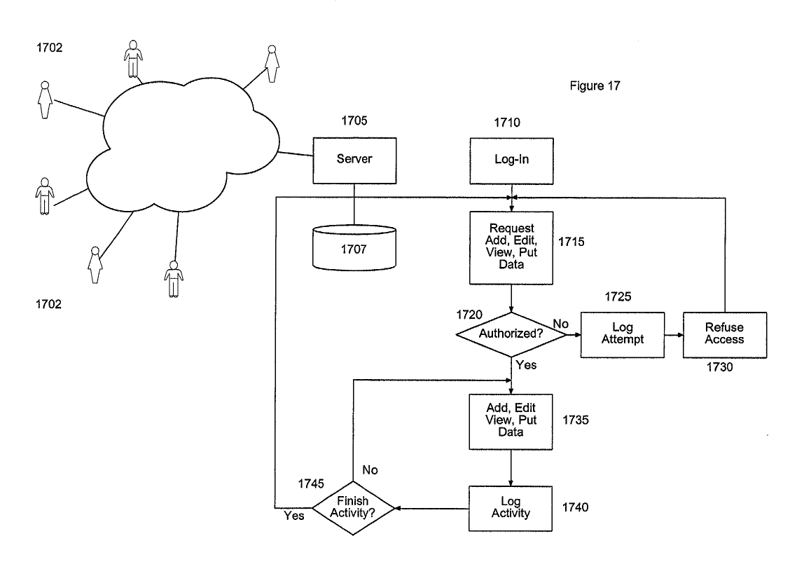

FIG. 17 depicts an illustration of an internal use embodiment of the present invention. The present invention may be configured such that users 1702 within organization 1704, such as a hospital, may realize its benefits in intra-organizational transfers. In a hospital, users 1702 could be, for example, nurses, doctors, therapists, administrators, lab technicians and pharmacy personnel. The present invention could be installed on server 1705, utilizing databases 1707, of organization 1704. User 1702 would log-in in block 1710 to server 1705. Next, users 1702 would request to add, edit, view or put data into databases 1707 in block 1715. If user 1702 is not authorized in decision point 1720, the attempt is logged in block 1725 and access is refused in block 1730. User 1702 is returned to the request point between block 1710 and block 1715. If user 1702 is authorized in decision point 1720, then user 1702 is allowed to add, edit, view and/or put data in block 1735. The system logs the activity in block 1740 of user 1702. When user 1702 finishes the requested activities in decision point 1745, user 1702 is returned to the request point between block 1710 and block 1715. While user 1702 continues activities in decision point 1745, user 1702 is returned to the access point between decision point 1720 and block 1735.

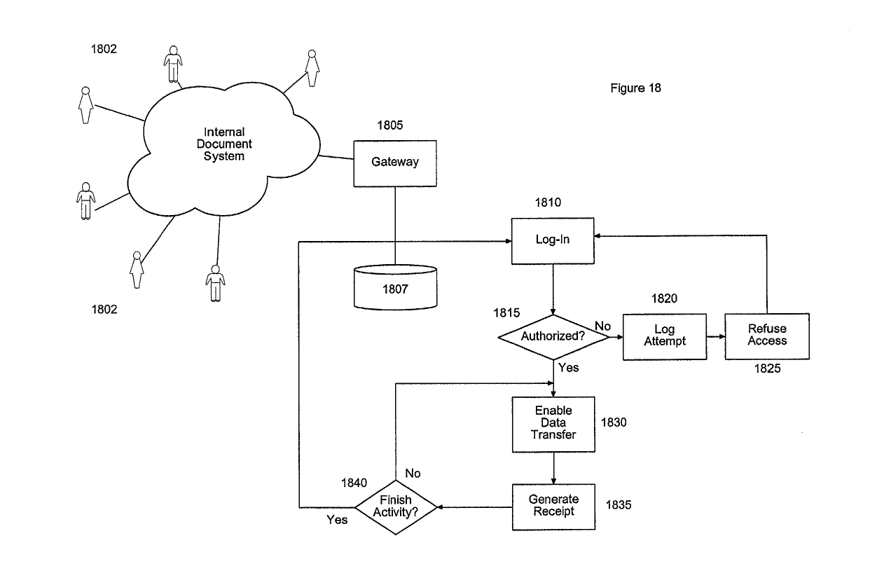

FIG. 18 depicts an alternative embodiment of the present invention. The present invention may be configured such that users 1802 utilize their own internal document system 1804 to process their own internal documents. In a hospital, users 1802 could be, for example, nurses, doctors, therapists, administrators, lab technicians and pharmacy personnel. The present invention would be installed as gateway 1805, utilizing its own databases 1807, or those of the organization (not shown). When user 1802 needs to transfer information extra-organizationally, the request to transfer would send user 1802 to gateway 1805, where user 1802 would be required to log-in in block 1810. A check would be performed to determine if user 1802 is authorized in decision point 1815. If user 1802 is not authorized in decision point 1815, the attempt is logged in block 1820 and access is refused in block 1825. User 1802 is returned log-in block 1810. If user 1802 is authorized in decision point 1815, then the data transfer is enabled in block 1830. The system generates a receipt recording the relevant transfer data in block 1835. The receipt can be stored in databases 1807 of the present invention or in organizational databases (not shown). When user 1802 finishes transferring data in decision point 1840, user 1802 is returned to log-in block 1810. While user 1802 continues transferring data in decision point 1840, user 1802 is returned to the access point between decision point 1815 and block 1830.

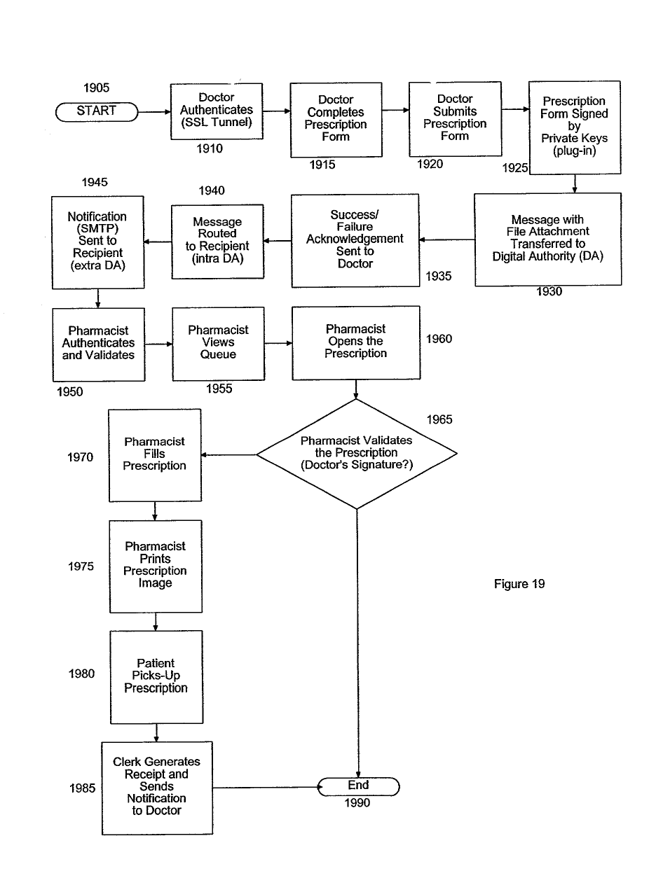

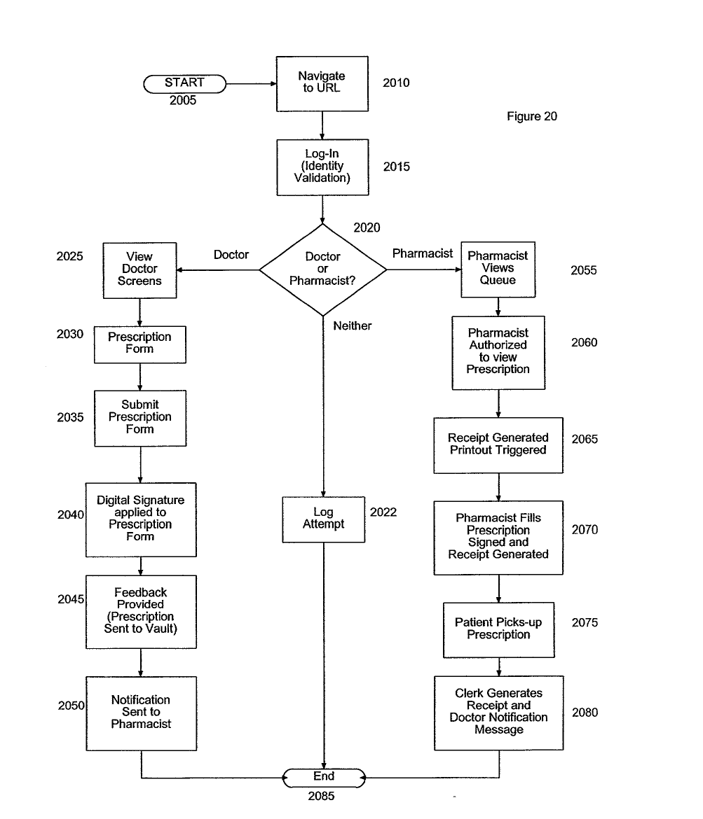

Alternative data flows are also possible, as shown in FIGS. 19 and 20. In FIG. 19, the data flow starts in block 1905. The doctor authenticates his/her identity via a secure socket layer (“SSL”) tunnel in block 1910. Then the doctor completes the prescription form in block 1915. The doctor submits the completed prescription form in block 1920. A plug-in using private keys signs the prescription form in block 1925 prior to transmittal. A message with the file attachment is then transferred to the Digital Authority (“DA”) in block 1930. A success/failure acknowledgement is then sent to the doctor in block 1935. Next, the message is routed to the recipient, remaining internal to the DA, in block 1940. A notification via SMTP is sent to the recipient, going external to the DA, in block 1945. The recipient, such as the pharmacist, authenticates and validates his/her identity in block 1950. Then, the pharmacist views the queue in block 1955. The pharmacist opens the prescription in block 1960. The pharmacist validates the prescription by verifying the doctor's signature in block 1965. If the signature is not valid, the system ends at block 1990. If the signature is valid, the pharmacist fills the prescription in block 1970. Next, the pharmacist prints the prescription image in block 1975. The patient picks-up the prescription in block 1980. A clerk generates a receipt and sends notification to the doctor in block 1985 that the prescription has been dispensed and picked-up. The data flow then ends in block 1990. Alternatively, the doctor could be a purchaser, the pharmacist a seller, and the prescription an order.

The data flow in FIG. 20 starts in block 2005. A user navigates to the URL in block 2010 where the user logs-in, validating his/her identity in block 2015. The system determines if the user is a doctor, a pharmacist or neither at decision point 2020. If neither, the data flow ends at block 2085. If the user is a doctor, the system allows viewing of the doctor screens in block 2025. The doctor accesses and completes the prescription form in block 2030 and then submits it in block 2035. A digital signature is applied to the prescription form in block 2040. Feedback is provided to the doctor regarding the status of the prescription, such as “Prescription Sent to Vault” in block 2045. Notification is sent to the pharmacist in block 2050 and that arm of the data flow ends in block 2085.

If the user is determined to be a pharmacist at decision point 1720, the pharmacist views the queue in block 1755. The pharmacist is authorized to view the prescription in block 1760. A receipt is generated and a printout triggered in block 1765 when the pharmacist opens the prescription. The pharmacist fills the prescription, which is then signed and a receipt generated in block 1770. The patient picks-up the prescription in block 1775. A clerk generates a receipt and a doctor notification message in block 1780. The data flow ends at block 1785. Alternatively, the doctor could be a purchaser, the pharmacist a seller, and the prescription an order.

While specific alternatives to steps of the present invention have been described herein, additional alternatives not specifically disclosed but known in the art are intended to fall within the scope of this invention. Thus, it is understood that other applications of the present invention will be apparent to those skilled in the art upon the reading of the described embodiments and a consideration of the appended claims and drawings.

What is claimed is:

1. A method for authorizing an electronic data transfer comprising the steps of:
receiving an authentication request containing a digital certificate from a requesting device via a communication link;
determining whether the digital certificate is valid;
creating an authentication response denying the authentication request when the digital certificate is not valid, or approving the authentication request when the digital certificate is valid;
sending the authentication response to the requesting device via the communication link; and
storing information about the electronic data transfer, the digital certificate and at least a portion of the authentication response.

2. The method as recited in claim 1 wherein the authentication request and the authentication response are transmitted via encrypted messages.

3. The method as recited in claim 1 wherein the step of determining whether the digital certificate is valid comprises the steps of:
sending a validation request for the digital certificate to a validation authority; and
receiving a validation response from the validation authority indicating whether or not the digital certificate is valid.

4. The method as recited in claim 1 wherein the authentication response includes a date/time stamp.

5. The method as recited in claim 1 wherein the authentication response includes a digital receipt.

6. The method as recited in claim 5 wherein the digital receipt includes an identification of an originator of the electronic data transfer.

7. The method as recited in claim 5 wherein the digital receipt includes an identification of a recipient of the electronic data transfer.

8. The method as recited in claim 1 wherein the information about the electronic data transfer includes an electronic document.

9. A method for authorizing an electronic data transfer comprising the steps of:
receiving an authentication request containing a digital certificate and information about the electronic data transfer from a requesting device via a communication link;
determining whether the digital certificate is valid;
creating an authentication response denying the authentication request when the digital certificate is not valid, or approving the authentication request when the digital certificate is valid;
sending the authentication response to the requesting device via the communication link;
creating a digital receipt for the electronic data transfer when the digital certificate is valid; and
storing the information about the electronic data transfer, the digital certificate and at least a portion of the authentication response.

10. The method as recited in claim 9 wherein the authentication request, the authentication response and the information about the electronic data transfer are transmitted via encrypted messages.

11. The method as recited in claim 9 wherein the step of determining whether the digital certificate is valid comprises the steps of:
sending a validation request for the digital certificate to a validation authority; and
receiving a validation response from the validation authority indicating whether or not the digital certificate is valid.

12. The method as recited in claim 9 wherein the digital receipt includes a date/time stamp.

13. The method as recited in claim 9 wherein the digital receipt includes an identification of an originator of the electronic data transfer.

14. The method as recited in claim 9 wherein the digital receipt includes an identification of a recipient of the electronic data transfer.

15. The method as recited in claim 9 wherein the digital receipt includes an action taken relating to the electronic data transfer.

16. The method as recited in claim 9 wherein the information about the electronic data transfer includes an electronic document.

17. A computer program embodied on a computer readable medium for authorizing an electronic data transfer comprising:
a code segment for receiving an authentication request containing a digital certificate from a requesting device via a communication link;
a code segment for determining whether the digital certificate is valid;
a code segment for creating an authentication response denying the authentication request when the digital certificate is not valid, or approving the authentication request when the digital certificate is valid;
a code segment for sending the authentication response to the requesting device via the communication link; and
a code segment for storing information about the electronic data transfer, the digital certificate and at least a portion of the authentication response.

18. The computer program as recited in claim 17 wherein the authentication request and the authentication response are transmitted via encrypted messages.

19. The computer program as recited in claim 17 wherein the a code segment for determining whether the digital certificate is valid comprises:
a code segment for sending a validation request for the digital certificate to a validation authority; and
a code segment for receiving a validation response from the validation authority indicating whether or not the digital certificate is valid.

20. The computer program as recited in claim 17 wherein the authentication response includes a date/time stamp.

21. The computer program as recited in claim 17 wherein the authentication response includes a digital receipt.

22. The computer program as recited in claim 21 wherein the digital receipt includes an identification of an originator of the electronic data transfer.

23. The computer program as recited in claim 21 wherein the digital receipt includes an identification of a recipient of the electronic data transfer.

24. The computer program as recited in claim 17 wherein the information about the electronic data transfer includes an electronic document.

25. A computer program embodied on a computer readable medium for authorizing an electronic data transfer comprising:
a code segment for receiving an authentication request containing a digital certificate and information about the electronic data transfer from a requesting device via a communication link;
a code segment for determining whether the digital certificate is valid;
a code segment for creating an authentication response denying the authentication request when the digital certificate is not valid, or approving the authentication request when the digital certificate is valid;
a code segment for sending the authentication response to the requesting device via the communication link;
a code segment for creating a digital receipt for the electronic data transfer when the digital certificate is valid; and
a code segment for storing the information about the electronic data transfer, the digital certificate and at least a portion of the authentication response.

26. The computer program as recited in claim 25 wherein the authentication request, the authentication response and the information about the electronic data transfer are transmitted via encrypted messages.

27. The computer program as recited in claim 25 wherein the a code segment for determining whether the digital certificate is valid comprises:
a code segment for sending a validation request for the digital certificate to a validation authority; and
a code segment for receiving a validation response from the validation authority indicating whether or not the digital certificate is valid.

28. The computer program as recited in claim 25 wherein the digital receipt includes a date/time stamp.

29. The computer program as recited in claim 25 wherein the digital receipt includes an identification of an originator of the electronic data transfer.

30. The computer program as recited in claim 25 wherein the digital receipt includes an identification of a recipient of the electronic data transfer.

31. The computer program as recited in claim 25 wherein the digital receipt includes an action taken relating to the electronic data transfer.

32. The computer program as recited in claim 25 wherein the information about the electronic data transfer includes an electronic document.

33. A system for authorizing an electronic data transfer comprising:
a computer;
a data storage device communicably linked to the computer;
a requesting device communicably linked to the computer; and
the computer receiving an authentication request containing a digital certificate from the requesting device, determining whether the digital certificate is valid, creating an authentication response denying the authentication request when the digital certificate is not valid, or approving the authentication request when the digital certificate is valid, sending the authentication response to the requesting device, and storing information about the electronic data transfer, the digital certificate and at least a portion of the authentication response on the data storage device.

34. The system as recited in claim 33 wherein the authentication request and the authentication response are transmitted via encrypted messages.

35. The system as recited in claim 33 further comprising:
a validation authority communicably linked to the computer via a second communication link; and
the computer determining whether the digital certificate is valid by sending a validation request for the digital certificate to a validation authority, and receiving a validation response from the validation authority indicating whether or not the digital certificate is valid.

36. The system as recited in claim 33 wherein the authentication response includes a date/time stamp.

37. The system as recited in claim 33 wherein the authentication response includes a digital receipt.

38. The system as recited in claim 37 wherein the digital receipt includes an identification of an originator of the electronic data transfer.

39. The system as recited in claim 37 wherein the digital receipt includes an identification of a recipient of the electronic data transfer.

40. The system as recited in claim 33 wherein the information about the electronic data transfer includes an electronic document.

41. A system for authorizing an electronic data transfer comprising:
a computer;
a data storage device communicably linked to the computer;
a requesting device communicably linked to the computer; and
the computer receiving an authentication request containing a digital certificate and information about the electronic data transfer from the requesting device, determining whether the digital certificate is valid, creating an authentication response denying the authentication request when the digital certificate is not valid, or approving the authentication request and creating a digital receipt for the electronic data transfer when the digital certificate is valid, sending the authentication response to the requesting device, and storing the information about the electronic data transfer, the digital certificate and at least a portion of the authentication response on the data storage device.

42. The system as recited in claim 41 wherein the authentication request, the authentication response and the information about the electronic data transfer are transmitted via encrypted messages.

43. The system as recited in claim 41 further comprising:
a validation authority communicably linked to the computer via a second communication link; and
the computer determining whether the digital certificate is valid by sending a validation request for the digital certificate to a validation authority, and receiving a validation response from the validation authority indicating whether or not the digital certificate is valid.

44. The system as recited in claim 41 wherein the digital receipt includes a date/time stamp.

45. The system as recited in claim 41 wherein the digital receipt includes an identification of an originator of the electronic data transfer.

46. The system as recited in claim 41 wherein the digital receipt includes an identification of a recipient of the electronic data transfer.

47. The system as recited in claim 41 wherein the digital receipt includes an action taken relating to the electronic data transfer.

48. The system as recited in claim 41 wherein the information about the electronic data transfer includes an electronic document.
